(19) United States
(12) Patent Application Publication
(10) Pub. No.: US 2011/0189480 A1
(43) Pub. Date: Aug. 4, 2011

(54) Magnesium Fastener Manufacturing Method and A Magnesium Fastener Member Produced Thereby

(76) Inventor: Kuo-Chen Hung, Kaohsiung (TW)

(21) Appl. No.: 12/783,703

(22) Filed: May 20, 2010

(30) Foreign Application Priority Data
Feb. 3, 2010 (TW) 099103099

(51) Int. Cl. B32B 15/02; C22C 23/00; B32B 15/04; B21D 31/00

(52) U.S. Cl. 428/379; 420/402; 72/362; 72/364

(57) ABSTRACT

A magnesium fastener manufacturing method includes the steps of: using a magnesium or a magnesium alloy to form a magnesium wire or a magnesium rod; processing cold forging, warm forging or hot forging the magnesium wire or the magnesium rod to form a magnesium fastener member. When processing warm or hot forging, a directly heating treatment, a thermal isolating and directly heating treatment, or a directly heating and thermal isolating treatment is selectively applied to heat the magnesium wire or a magnesium rod to a predetermined temperature.

### BACKGROUND OF THE INVENTION

1. Field of the Invention The present invention relates to a magnesium fastener manufacturing method and a magnesium fastener member produced thereby. More particularly, the present invention relates to a magnesium fastener manufacturing method for cold, warm or hot forging a magnesium wire or rod to produce a magnesium fastener member.

2. Description of the Related Art

U.S. Pat. No. 6,328,657, entitled “Threaded fastener and a method of making the same,” discloses a threaded fastener or the likes directly made by a moderate temperature-forging process and from a raw magnesium material. The raw material may be selected from pure magnesium provided with industrial grade or any magnesium alloy. Before forging operation, the raw magnesium material has a degree of a superplastic property, and a fine-granulated metallographic internal texture.

In the above manufacturing method, a predetermined shape of the threaded fastener is directly forged and formed from various original shapes of the raw material of pure magnesium or magnesium alloys in the moderate temperature-forging process. However, the above manufacturing method is lack of consideration to directly forge the original shapes of the raw magnesium material suitable for forming the predetermined shape of the threaded fastener. In fact, there is no pretreatment or pre-treating step before forging the raw magnesium material so as to simplify the process. It will be known in the art that the directly forging method for the raw magnesium material is rarely successful and cannot simplify the entire process.

However, there is a need of improving the directly forging method for the raw magnesium material to reduce the difficulties and problems in manufacturing a magnesium fastener member. In other words, there is a need of providing an improved fastener manufacturing method suitable for mass production.

As is described in greater detail below, the present invention provides a magnesium fastener manufacturing method and a magnesium fastener member produced thereby. Prior to cold, warm or hot forging, a preformed magnesium wire or rod with a predetermined diameter is formed from a raw magnesium or magnesium alloy material, and forged to produce a forged piece of the magnesium fastener member in such a way as to mitigate and overcome the above problem.

### SUMMARY OF THE INVENTION

The primary objective of this invention is to provide a magnesium fastener manufacturing method and a magnesium fastener member produced thereby. A preformed magnesium wire or rod with a predetermined diameter is formed from a raw magnesium or magnesium alloy material, and the wire or rod is forged to produce a forged piece of the magnesium fastener member. Accordingly, the magnesium fastener manufacturing method is successful in simplifying the entire process.

The magnesium fastener manufacturing method in accordance with an aspect of the present invention includes the steps of:
providing a preformed magnesium wire or rod with a predetermined diameter from a raw magnesium or magnesium alloy material; and
directly forging the preformed magnesium wire or rod to produce a forged piece of a magnesium fastener product.

As is described above, a magnesium fastener member comprises a forged piece forged from a preformed magnesium wire or rod made from a raw magnesium or magnesium alloy material, wherein the preformed magnesium wire or rod has a predetermined diameter for forging.

In a separate aspect of the present invention, the magnesium fastener manufacturing method includes the steps of:
providing a preformed magnesium wire or rod with a predetermined diameter from a raw magnesium or magnesium alloy material;
heating the preformed magnesium wire or rod to a predetermined temperature; and
directly forging the heated magnesium wire or rod to produce a forged piece of a magnesium fastener product.

As is described above, a magnesium fastener member comprises a forged piece forged from a heated magnesium wire or rod, the heated magnesium wire or rod heated from a preformed magnesium wire or rod made from a raw magnesium or magnesium alloy material, wherein the preformed magnesium wire or rod has a predetermined diameter for forging.

In a further separate aspect of the present invention, the magnesium fastener manufacturing method includes the steps of:
providing a preformed magnesium wire or rod with a predetermined diameter from a raw magnesium or magnesium alloy material;
processing a thermal isolating procedure on the preformed magnesium wire or rod, and subsequently heating the magnesium wire or rod to a predetermined temperature; and
directly forging the heated magnesium wire or rod to produce a forged piece of a magnesium fastener product.

As is described above, a magnesium fastener member comprises a forged piece forged from a heated magnesium wire or rod, the heated magnesium wire or rod heated from a coated magnesium wire or rod with a thermal isolating material, the coated magnesium wire or rod selected from a preformed magnesium wire or rod which is made from a raw magnesium or magnesium alloy material, wherein the preformed magnesium wire or rod has a predetermined diameter for forging.

In yet a further separate aspect of the present invention, the magnesium fastener manufacturing method includes the steps of:
providing a preformed magnesium wire or rod with a predetermined diameter from a raw magnesium or magnesium alloy material;
heating the preformed magnesium wire or rod to a predetermined temperature, and subsequently processing a thermal isolating procedure on the heated magnesium wire or rod; and
directly forging the coated magnesium wire or rod to produce a forged piece of a magnesium fastener product.

As is described above, a magnesium fastener member comprises a forged piece forged from a coated magnesium wire or rod with a thermal isolating material, the coated magnesium wire or rod coated on a heated magnesium wire or rod, the heated magnesium wire or rod heated from a preformed magnesium wire or rod which is made from a raw magnesium or magnesium alloy material, wherein the preformed magnesium wire or rod has a predetermined diameter for forging.

In yet a further separate aspect of the present invention, the predetermined temperature ranges between 100 □ and 300 □.

In yet a further separate aspect of the present invention, the thermal isolating procedure includes the step of: coating a thermal isolating material on the magnesium wire or rod.

In yet a further separate aspect of the present invention, the thermal isolating material is selected from an inorganic material or an organic material.

In yet a further separate aspect of the present invention, the inorganic material is selected from graphite or boron nitride (BN).

Further scope of the applicability of the present invention will become apparent from the detailed description given hereinafter. However, it should be understood that the detailed description and specific examples, while indicating preferred embodiments of the invention, are given by way of illustration only, since various modifications will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a flow chart of a magnesium fastener manufacturing method in accordance with a first preferred embodiment of the present invention.

FIG. 2 is a flow chart of a magnesium fastener manufacturing method in accordance with a second preferred embodiment of the present invention.

FIG. 3 is a flow chart of a magnesium fastener manufacturing method in accordance with a third preferred embodiment of the present invention.

FIG. 4 is a flow chart of a magnesium fastener manufacturing method in accordance with a fourth preferred embodiment of the present invention.

### DETAILED DESCRIPTION OF THE INVENTION

It is noted that a magnesium fastener manufacturing method in accordance with the preferred embodiment of the present invention is suitable for producing various fasteners, for example, including rivets, pins, studs, double-headed studs, washers and other special fasteners which are not limitative of the present invention.

A magnesium fastener member produced by the magnesium fastener manufacturing method in accordance with the preferred embodiment of the present invention is made from magnesium or magnesium alloys which have a perfect degree of physical and chemical characteristics of magnesium metal. It will be understood that the magnesium fastener member may not be made from other ordinary metals, including stainless steel, low-carbon steel (mild steel), medium carbon steel, alloy steel and bronze, for example.

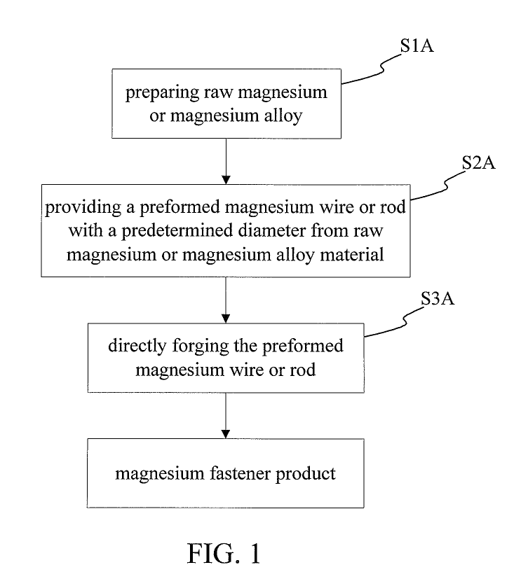

FIG. 1 shows a flow chart of a magnesium fastener manufacturing method in accordance with a first preferred embodiment of the present invention. With continued reference to FIG. 1, the magnesium fastener manufacturing method includes the step S1A of: preparing a raw magnesium or magnesium alloy material in a proper smelting procedure. The magnesium or magnesium alloy material is suitable for forging operation to produce a fastener member which still possesses several characteristics of magnesium, for example: light-weight metal.

Still referring to FIG. 1, the magnesium fastener manufacturing method includes the step S2A of: pre-forming a magnesium wire or rod from the raw magnesium or magnesium alloy material prior to forging operation. In a preferred embodiment, the magnesium wire or rod can be formed by casting or the like. The magnesium wire or rod has a predetermined diameter suitable for cold, warm or hot forging so as to avoid requiring a complicated forging process.

In the preferred embodiment, the predetermined diameter of the pre-formed magnesium wire or rod corresponds to a minimum diameter or a minimum average of diameters of the fastener member; a total length of the pre-formed magnesium wire or rod corresponds to that of the fastener member.

Referring again to FIG. 1, the magnesium fastener manufacturing method includes the step S3A of: directly forging the preformed magnesium wire or rod in a forging machine for cold forging and other processing machines to form a forged piece. In the preferred embodiment, one-step or multi-step forging is applied to the preformed magnesium wire or rod. After cold forging, the preformed magnesium wire or rod is formed as a predetermined shape of a magnesium fastener product.

Furthermore, the magnesium fastener product may be treated with a single treatment process or a series of treatment processes, including surface treatment, electroplating treatment and chemical plating treatment, according to the need.

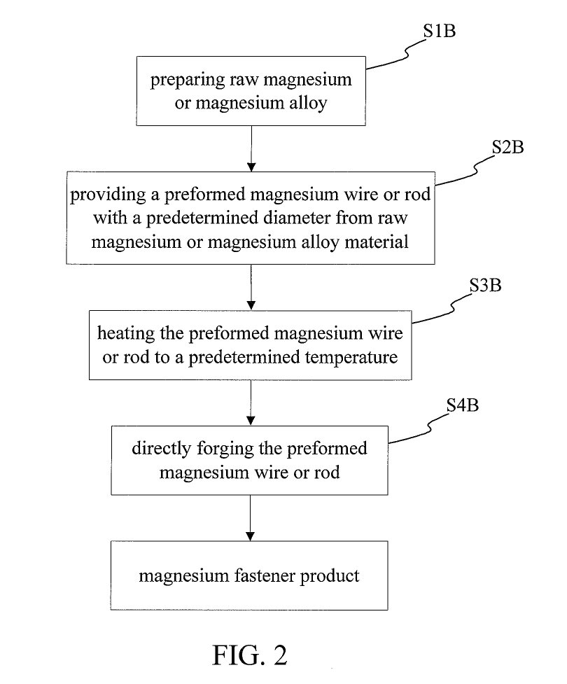

Turning now to FIG. 2, a flow chart of a magnesium fastener manufacturing method in accordance with a second preferred embodiment of the present invention is shown. Steps S1B and S2B of the second embodiment are identical with steps S1A and S2A of the first embodiment and the detail description of steps S1B and S2B are omitted.

Referring to FIG. 2, the magnesium fastener manufacturing method of the second preferred embodiment includes the step S3B of: directly heating the preformed magnesium wire or rod to a predetermined temperature in a heater. The predetermined temperature ranges between 100 □ and 300 □ which is not limitative of the present invention.

Still referring to FIG. 2, the magnesium fastener manufacturing method of the second preferred embodiment includes the step S4B of: directly forging the heated magnesium wire or rod in a forging machine for warm or hot forging and other processing machines to form a forged piece. In the preferred embodiment, one-step or multi-step forging is applied to the heated magnesium wire or rod. After warm or hot forging, the heated magnesium wire or rod is formed as a predetermined shape of a magnesium fastener product.

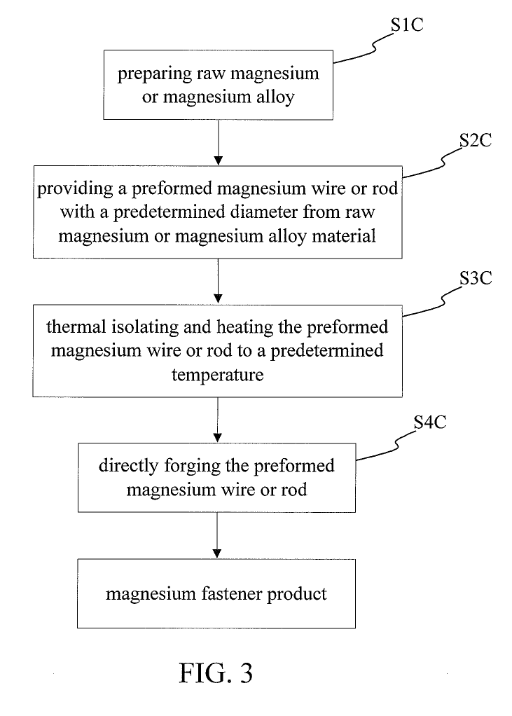

Turning now to FIG. 3, a flow chart of a magnesium fastener manufacturing method in accordance with a third preferred embodiment of the present invention is shown. Steps S1C, S2C and S4C of the third embodiment are identical with steps S1B, S2B and S4B of the second embodiment and the detail description of steps S1C, S2C and S4C are omitted.

Still referring to FIG. 3, the magnesium fastener manufacturing method of the third preferred embodiment includes the step S3C of: processing a thermal isolating procedure on the preformed magnesium wire or rod, and subsequently heating the thermal isolated magnesium wire or rod to a predetermined temperature in a heater. It will be understood that a thermal isolating and directly heating treatment is applied to the magnesium wire or rod. In step S3C, prior to heating and forging, a thermal isolating material is coated on the preformed magnesium wire or rod so as to avoid thermal energy loss from the magnesium wire or rod to the ambient environment. By way of example, the coating technology may be roller coating or spray coating which is not limitative of the present invention.

In the third preferred embodiment, the thermal isolating material may be selected from an inorganic material or an organic material. The inorganic material of the thermal isolating material may be selected from graphite or boron nitride (BN).

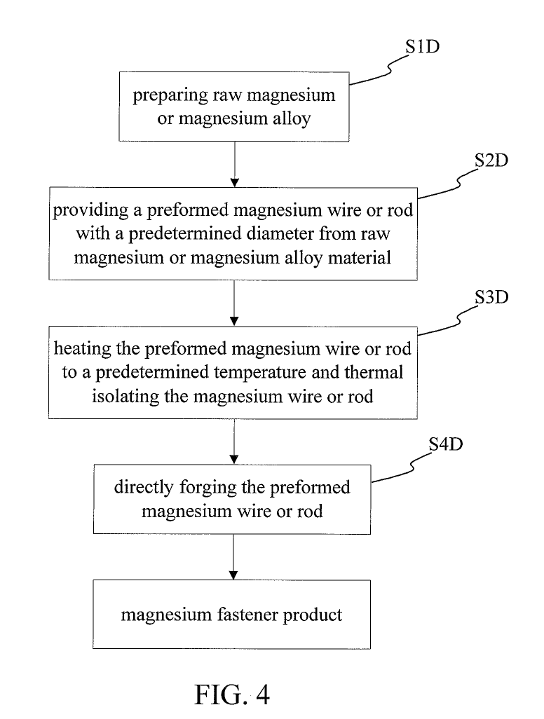

Turning now to FIG. 4, a flow chart of a magnesium fastener manufacturing method in accordance with a fourth preferred embodiment of the present invention is shown. Steps S1D, S2D and S4D of the fourth embodiment are identical with steps S1B, S2B and S4B of the second embodiment and the detail description of steps S1D, S2D and S4D are omitted.

Still referring to FIG. 4, the magnesium fastener manufacturing method of the fourth preferred embodiment includes the step S3D of: heating the preformed magnesium wire or rod to a predetermined temperature in a heater, and subsequently processing a thermal isolating procedure on the heated magnesium wire or rod. It will be understood that a directly heating and thermal isolating treatment is applied to the magnesium wire or rod. In step S3D, after heating and prior to forging, a thermal isolating material is coated on the heated magnesium wire or rod so as to avoid thermal energy loss from the magnesium wire or rod to the ambient environment.

Although the invention has been described in detail with reference to its presently preferred embodiment(s), it will be understood by one of ordinary skill in the art that various modifications can be made without departing from the spirit and the scope of the invention, as set forth in the appended claims.

What is claimed is:

1. A magnesium fastener manufacturing method, comprising the steps of:
providing a preformed magnesium wire or rod with a predetermined diameter from a raw magnesium or magnesium alloy material, the predetermined diameter corresponding to a minimum diameter of the magnesium fastener; and
directly forging the preformed magnesium wire or rod to produce a forged piece of a magnesium fastener product.

2. The magnesium fastener manufacturing method as defined in claim 1, further comprising the step of: heating the preformed magnesium wire or rod to a predetermined temperature.

3. The magnesium fastener manufacturing method as defined in claim 2, wherein the predetermined temperature ranges between ranges between 100 □ and 300 □.

4. The magnesium fastener manufacturing method as defined in claim 1, further comprising the step of: processing a thermal isolating procedure on the preformed magnesium wire or rod, and subsequently heating the magnesium wire or rod to a predetermined temperature.

5. The magnesium fastener manufacturing method as defined in claim 4, wherein a thermal isolating material is coated on the preformed magnesium wire or rod.

6. The magnesium fastener manufacturing method as defined in claim 5, wherein the thermal isolating material is selected from an inorganic material or an organic material.

7. The magnesium fastener manufacturing method as defined in claim 6, wherein the inorganic material is selected from graphite or boron nitride.

8. The magnesium fastener manufacturing method as defined in claim 4, wherein the predetermined temperature ranges between ranges between 100 □ and 300 □.

9. The magnesium fastener manufacturing method as defined in claim 1, further comprising the step of: heating the magnesium wire or rod to a predetermined temperature, and subsequently processing a thermal isolating procedure on the heated magnesium wire or rod.

10. The magnesium fastener manufacturing method as defined in claim 9, wherein a thermal isolating material is coated on the preformed magnesium wire or rod.

11. The magnesium fastener manufacturing method as defined in claim 10, wherein the thermal isolating material is selected from an inorganic material or an organic material.

12. The magnesium fastener manufacturing method as defined in claim 11, wherein the inorganic material is selected from graphite or boron nitride.

13. The magnesium fastener manufacturing method as defined in claim 9, wherein the predetermined temperature ranges between ranges between 100 □ and 300 □.

14. A magnesium fastener member comprising:
a forged piece forged from a preformed magnesium wire or rod made from a raw magnesium or magnesium alloy material,
wherein the preformed magnesium wire or rod has a predetermined diameter corresponding to a minimum diameter of the magnesium fastener.

15. A magnesium fastener member comprising:
a forged piece forged from a heated magnesium wire or rod, the heated magnesium wire or rod heated from a preformed magnesium wire or rod made from a raw magnesium or magnesium alloy material,
wherein the preformed magnesium wire or rod has a predetermined diameter corresponding to a minimum diameter of the magnesium fastener.

16. The magnesium fastener member as defined in claim 15, wherein, prior to heating and forging the magnesium wire or rod, a thermal isolating material is coated on the magnesium wire or rod.

17. The magnesium fastener member as defined in claim 16, wherein the thermal isolating material is selected from an inorganic material or an organic material.

18. The magnesium fastener member as defined in claim 15, wherein, after heating and prior to forging the magnesium wire or rod, a thermal isolating material is coated on the heated magnesium wire or rod.

19. The magnesium fastener member as defined in claim 18, wherein the thermal isolating material is selected from an inorganic material or an organic material.
